(19) United States
(12) Patent Application Publication
(10) Pub. No.: US 2018/0111506 A1
(43) Pub. Date: Apr. 26, 2018

(54) VEHICLE SAFETY SYSTEM AND METHOD

(71) Applicant: Taleese Penna, Kawungan (AU)

(72) Inventor: Taleese Penna, Kawungan (AU)

(21) Appl. No.: 15/560,843

(22) PCT Filed: Mar. 21, 2016
(86) PCT No.: PCT/AU2016/050198

§ 371 Date: Sep. 22, 2017

(30) Foreign Application Priority Data
Mar. 24, 2015 (AU) 2015901053

(51) Int. Cl. B60N 2/00; B60Q 5/00; B60R 16/037; B60R 16/04; B60R 11/04; B60H 1/00; G08B 21/02

(52) U.S. Cl. CPC B60N 2/002; B60Q 5/005; B60R 16/037; B60R 16/04; B60R 11/04; G08B 21/24; B60H 1/00742; G08B 21/0225; G08B 21/028; B60Y 2400/302; B60H 1/00978

(57) ABSTRACT

A vehicle safety system and method is provided for preventing heat related injuries in hot cars. The system includes a sensor, to sensing the presence of a child or animal in a stationary vehicle; and a controller, configured to issue an alert in response to the detection of the presence of the child or animal in the vehicle. The controller may also be for controlling a change in temperature in the vehicle in response to detection of the presence of the child or animal in the vehicle.

### TECHNICAL FIELD

The present invention relates to vehicle safety, and in particular to devices that may assist in preventing children from perishing inside a hot vehicle.

### BACKGROUND ART

In moderate to warm environments, a temperature of an inside of a vehicle can quickly become very high when parked. As an illustrative example, the inside of a vehicle may reach 70° C. in as little as 10 minutes when the outside temperature is as little as 30° C. Even at lower outside temperatures, temperatures inside a vehicle can quickly become high, particularly if the vehicle is parked in direct sunlight.

Unfortunately, each year a number of children die in hot vehicles. The thermoregulatory system of a child is not as efficient as that of an adult, and as a result, children are far more susceptible to heatstroke and heat related injuries than adults.

Various attempts have been made to prevent children from being left in vehicles. These systems generally utilise sensors associated with child restraints, to detect that a child is still strapped into a child restraint when the vehicle is turned off.

A problem with these systems of the prior art is that children may gain access to a vehicle without the knowledge of their caregiver, and as such, may be trapped inside a vehicle without being strapped into a child restraint. As a result, even if such a system is fitted to a vehicle, it will not engage when a children is not strapped into the child restraint.

As a result, there is a need for an improved vehicle safety system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to vehicle safety systems, which may at least partially overcome at least one of the abovementioned disadvantages or provide the consumer with a useful or commercial choice.

With the foregoing in view, the present invention in one form, resides broadly in a vehicle safety system including:

a sensor, to sensing the presence of a child or animal in a stationary vehicle; and

a controller, configured to issue an alert in response to the detection of the presence of the child or animal in the vehicle.

The controller may be configured to control a change in temperature in the vehicle in response to the detect of the presence of the child or animal in the vehicle.

The controller may be configured to cause the temperate of the vehicle to decrease. The controller may be configured to activate a fan of the vehicle, activate air conditioning of the vehicle and/or open a window of the vehicle to cause the temperate of the vehicle to decrease.

The controller may be configured to cause the temperate of the vehicle to increase. The controller may be configured to activate a heater of the vehicle or close a window of the vehicle.

The system may include a temperature sensor, for sensing a temperature in the vehicle.

The controller may be configured to increase or decrease the temperature in the vehicle based upon the temperature of the vehicle. In particular, if the vehicle is hot, the controller may be configured to cool the vehicle, and if the vehicle is cold, the controller may be configured to heat the vehicle.

The controller may activate an alarm or signalling device of the vehicle. An example of a signalling device of the vehicle is a horn of the vehicle. Deactivation of the alarm may only be completed using a key at the vehicle.

The system may be powered by a rechargeable battery that is independent to a battery of the vehicle. As such, the system may operate without draining vehicle battery.

The controller may be configured to send a message to a remote device, based at least in part on the presence of the child or animal in the vehicle.

The system may include a positioning module, for determining position of the vehicle. The position of the vehicle may be sent in the message to the remote device. The positioning module may comprise a Global Positioning System (GPS) module.

The controller may be configured to send a first message when first threshold criteria are met, and a second message when second threshold criteria are met. The first message may be sent to a registered user of the system, and the second message may be sent to an alarm centre.

The first and second threshold criteria may comprise temperature thresholds from a temperature sensor of the system. The first and second threshold criteria may include time-based thresholds.

The system may include a camera, to capture images of an interior of vehicle. The images may be sent on in the message to the remote device.

The sensor may comprise movement sensor. The sensor may be configured to detect movement in several areas of vehicle. The several areas may include front seats of the vehicle and rear seats of the vehicle. The sensor may be configured to detect movement in substantially an entire interior of the vehicle.

The system may be configured to determine a pattern of movement base upon sensor data. For example, the system may trigger an alert after 2 minutes of movement.

The system may be configured to be placed on a front dash of the vehicle, and directed backwards toward an interior of the vehicle.

In another form, the present invention resides broadly in a vehicle safety method including:

sensing, using a sensor in a stationary vehicle, the presence of a child or animal in the vehicle; and

issuing an alert in response to the detection of the presence of the child or animal in the vehicle.

The method may further include controlling, using a controller, a change in temperature in the vehicle in response to the detection of the presence of the child or animal in the vehicle.

The method may include sensing a temperature in the vehicle.

The method may include activating an alarm associated with the vehicle.

The method may include sending a message to a remote device, based at least in part on the presence of the child or animal in the vehicle.

The method may include determining a position of the vehicle, and providing the position in the message.

The method may include sending a first message when first threshold criteria are met, and a second message when second threshold criteria are met. The first message may be sent to a registered user of the system, and the second message may be sent to an alarm centre.

The method may include capturing images of an interior of vehicle. The images may be sent on in the message to the remote device.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a vehicle safety system, according to an embodiment of the present invention;

FIG. 2 illustrates a vehicle safety system, according to an embodiment of the present invention;

FIG. 3 illustrates a top cutaway view of a vehicle with the system of FIG. 2 installed, according to an embodiment of the present invention;

FIG. 4 illustrates a vehicle safety method, according to an embodiment of the present invention;

FIG. 5 illustrates a vehicle safety system, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

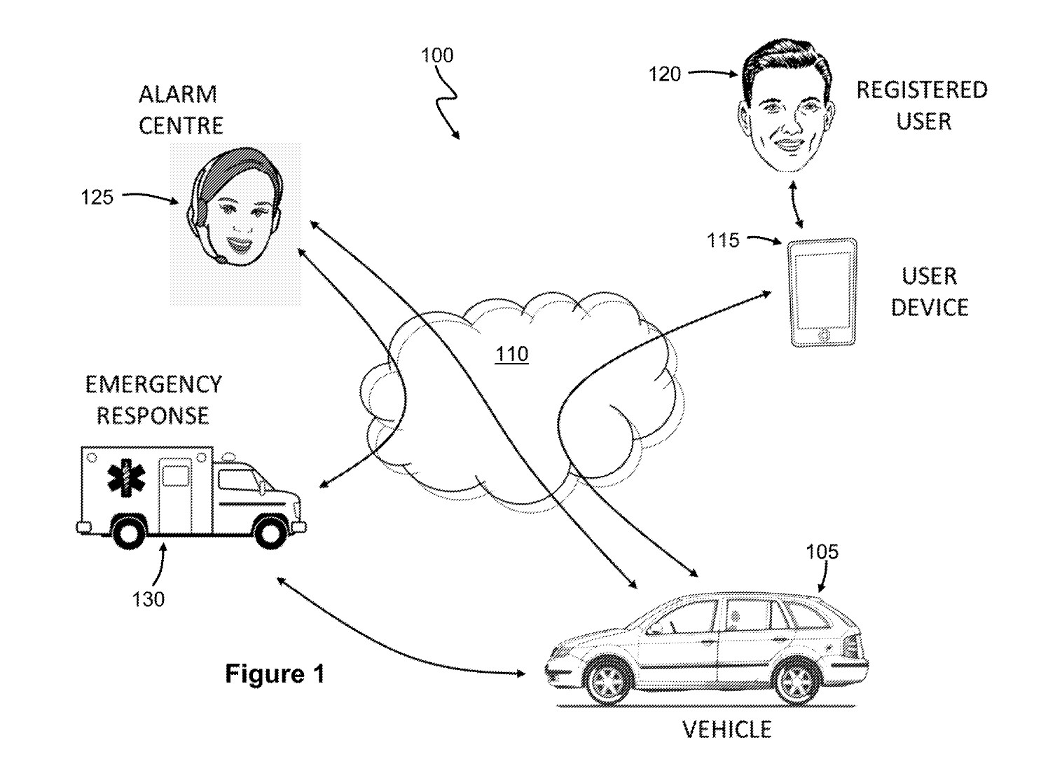

FIG. 1 illustrates a vehicle safety system 100, according to an embodiment of the present invention. The vehicle safety system 100 is particularly suited to preventing children from dying in hot cars.

The system 100 includes a vehicle 105 including sensors, alarms and a data interface, as described in further detail below. In particular, the vehicle 105 is able to detect the presence of a child in the car, a temperature of the car, and activate components of the vehicle (such as air conditioning) based thereon.

Furthermore, the vehicle 105 includes a data interface (not illustrated), for wireless data communication. In particular, the vehicle 105 is coupled to a data network 110, such as the Internet, such that it can provide warning messages to a user device 115 of a registered user 120 associated with the vehicle 105, upon detection of a child in the vehicle 105, for example when the vehicle 105 is hot.

The warning messages may comprise text messages, phone calls, or any other suitable message. According to certain embodiments, the user device 115 includes an app configured to activate an alarm of the user device 115, which may be audible and/or visual.

The vehicle 105 may include a Global Positioning System (GPS) sensor, or another form of positioning sensor. As such, the warning message may be sent together with coordinates (or a map) to remind or inform the registered user of the location of the vehicle 105.

The vehicle 105 is further coupled to an alarm centre 125 by the data network 110. A message may be sent to the alarm centre 125 if a child is detected in the vehicle, and the message may include location data, as discussed above. The alarm centre 125 may then engage emergency response 130, who may attend to the vehicle 105.

According to certain embodiments, the warning message is sent once a certain temperature is reached in the vehicle 105 (and a child is detected), after a certain time at a particular temperature, or if it appears likely that the temperature will reach a hazardous level within a short period. Similarly, the warning message may be sent to the registered user 120 upon a first set of threshold criteria being met, and to the alarm centre 125 upon a second set of threshold criteria being met.

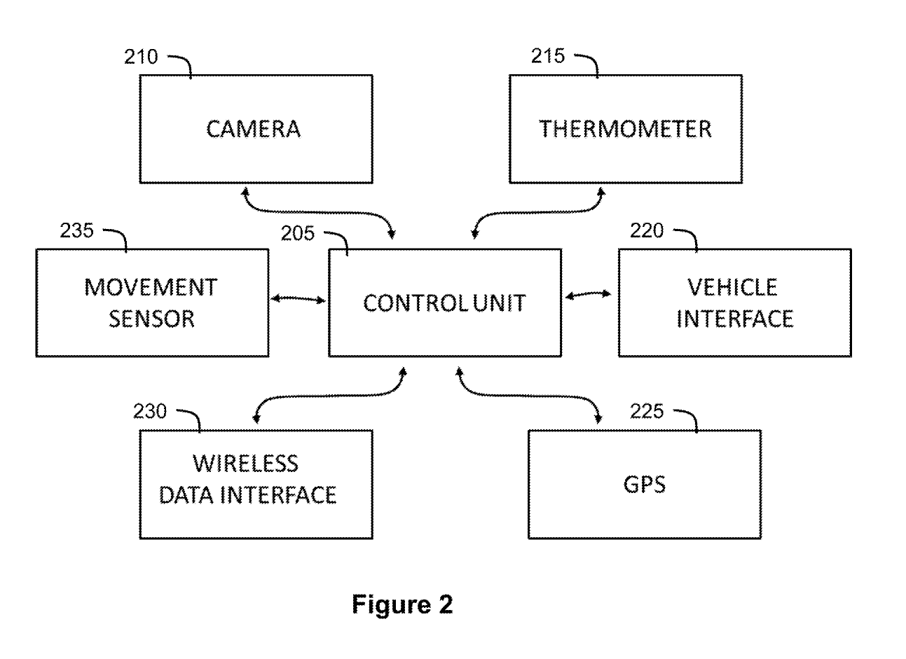

FIG. 2 illustrates a vehicle safety system 200, according to an embodiment of the present invention. The vehicle safety system 200 may form part of the vehicle safety system 100 of FIG. 1, and may reside in the vehicle 105.

The system 200 includes a central control unit 205 which controls communication between different modules of the system 200. In particular, the control unit 205 is coupled to a camera 210, a thermometer 215, a vehicle interface 220, a GPS module 225, a wireless data interface 230 and a movement sensor 235.

In use, the system 200 is activated when a vehicle is not in motion, e.g. parked. The movement sensor 235, which may comprise an infrared movement sensor, detects movements in the vehicle 105 from, for example, a child or an animal. The movement sensor 235 may require prolonged movement to be detected, to avoid an alarm being raised based upon signal noise or the like.

The thermometer 215 measures a temperature inside the vehicle 105. The temperature may be measured at various points in the vehicle and averaged, or simply measured at a single representative point.

If a child is detected in the vehicle, and the temperature is greater than a threshold, the system 100 may start the engine and activate the air conditioning of the vehicle 105 using the vehicle interface 220. As a result, the temperature inside the vehicle 105 will generally drop quickly.

The vehicle interface 220 enables the system 200 to communicate with the vehicle 105, for example using a controller area network (CAN) bus, or other suitable interface. Other features of the vehicle 105 may also be controlled by the system 200, including an alarm, a horn or signalling device, or the windows or sunroof.

After activating the air conditioning, the system 200 may send a message to the user device 115 or with the alarm centre 125 by the wireless data interface 230. Such message may include temperature details (from the thermometer 215), location data (from the GPS module 225), and/or image data from the camera 210.

The camera 210 is directed to capture images of an interior of the vehicle 105, for example from the front of the vehicle 105 rearwards, or from a roof of the vehicle 105 downwards. The camera 210 may include a speaker and microphone, and/or a display screen, to enable a person to confirm a trapped child.

The camera 210 may be a thermal or infrared camera, or operate in the visible spectrum (i.e. a traditional camera).

This system 200 may be powered by a battery (not shown) of the vehicle 105, or by an internal rechargeable battery (not shown), which is recharged by the battery of the vehicle 105. As such, the system 200 may operate continuously when vehicle 105 is not in use, without draining the battery of the vehicle 105. The rechargeable battery may last up to a week without being recharged. A warning signal may be provided when the rechargeable battery is low. Alternatively, the rechargeable battery may be automatically recharged from the battery of the vehicle 105.

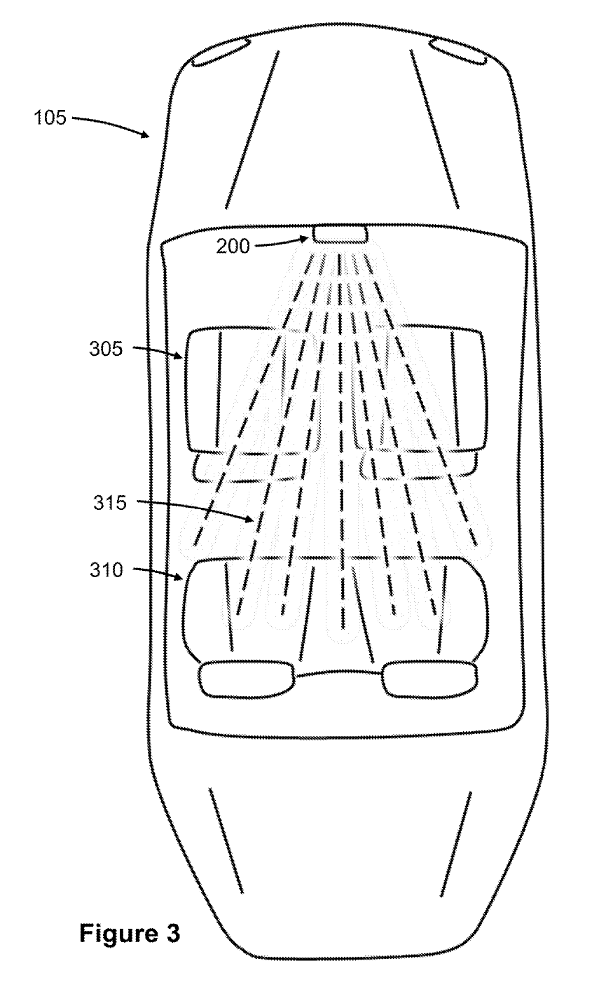

FIG. 3 illustrates a top cutaway view of the vehicle 105 with the system 200 installed, according to an embodiment of the present invention.

The system 200 comprises an aftermarket module, which is installed in a front dash of the vehicle 105 and is coupled to the battery and a data interface of the vehicle 105. However, the skilled addressee will readily appreciate that the system 200 may be integrated with the vehicle 105 at a time of manufacture.

The vehicle 105 has front seats 305 and rear seats 310. The motion sensor (not shown) is configured to detect movement in both the front seats 305, the rear seats 310, and there between, as illustrated by sensor rays 315.

The motion sensor may be in a front of the vehicle facing backwards (as illustrated), on a roof of the vehicle facing downwards, and/or at a rear of vehicle facing forwards, for example to detect rear facing infants. In such case, the system may also be used to provide an image of the child during vehicle operation.

The above description focuses on detecting children in hot vehicles. However the skilled addressee will readily appreciate that the system may be used to detect people (including children) in hot vehicles, cold vehicles, or in vehicles generally. Similarly, the system 100 may be used to detect animals, such as dogs, in hot or cold vehicles.

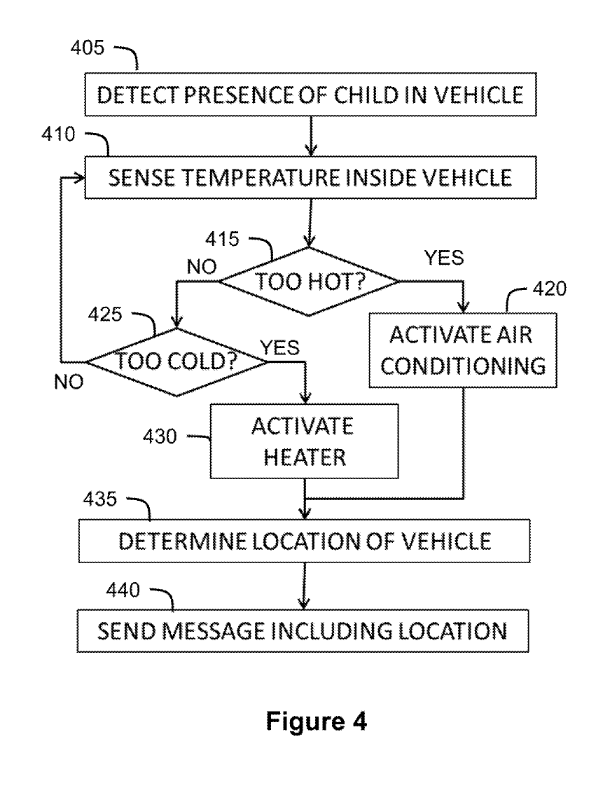

FIG. 4 illustrates a vehicle safety method 400, according to an embodiment of the present invention.

At step 405, the presence of a child is detected in a stationary vehicle, such as the vehicle 105 of FIG. 1. The child may be detected using the movement sensor 235 of FIG. 2, or by any suitable means. The presence of the child may be determined based upon an established pattern of movement that has been consistently detected for at least 2 minutes.

As step 410, a temperature inside the vehicle is sensed. This may be achieved using the temperature sensor 215 of FIG. 2, or by any suitable means.

At step 415, it is determined if the temperature inside the vehicle is too hot. According to certain embodiments, the vehicle is too hot if the temperature inside the vehicle is greater than about 37.3° C.

If the temperature inside the vehicle is too hot, the air conditioning of the vehicle is activated in step 420. Alternatively, it is determined if the temperature inside the vehicle is too cold.

If the temperature inside the vehicle is too cold, the heater is activated in step 430. Alternatively, the temperature is sensed again in 410, and the process is repeated.

After the heater is activated, the location of the vehicle is determined in step 435. This may be achieved using the GPS module 225 of FIG. 2, or by any suitable means.

At step 440, a message is sent to a remote device (e.g. a user or an alarm centre), including the location of the vehicle.

According to certain embodiments, an internal camera is also activated, to record and send data in real time to a software application on a remote device, together with the temperature data.

The skilled addressee will readily appreciate that the step of activating the air conditioning may include starting the vehicle.

The message may be sent via text message to the registered owner of vehicle and/or to local authorities.

For vehicles with manual transmission, the powered windows may be lowered and/or a fan may be activated instead of starting the engine and activating the air conditioning, particularly if the vehicle is in gear.

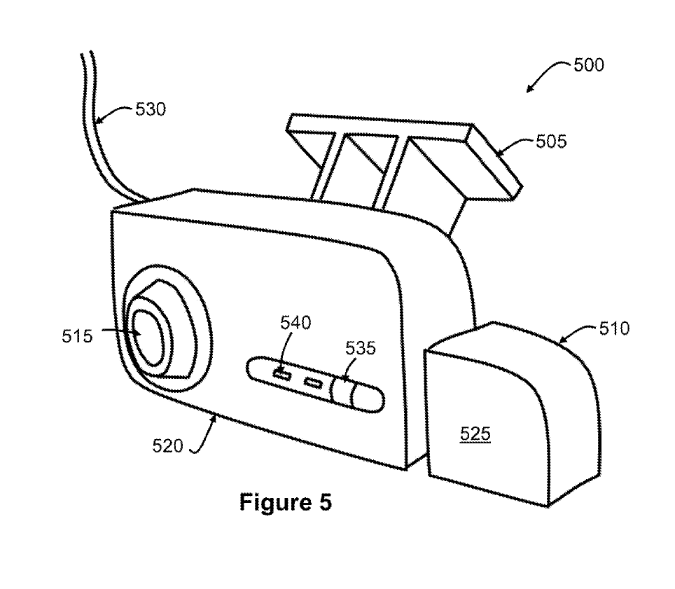

FIG. 5 illustrates a vehicle safety system 500, according to an embodiment of the present invention. The vehicle safety system 500 may be similar or identical to the vehicle safety system 200.

The system 500 is configured to be attached to a dash or windscreen of a vehicle by a mount 505. The mount 505 may include adhesive, for semi-permanently mounting the system in a vehicle, or temporarily attached, e.g. using suction cups. This enables the system 500 to be used in a wide variety of vehicles, including daily use vehicles, and one off vehicles such as rental cars.

The system 500 includes an external camera 510, for recording video of an outside of the vehicle, and an internal camera 515, for recording video of an inside of the vehicle. The internal camera 515 is positioned on a body 520 of the system 500, which may be pivoted relative to the mount 505 to adjust a field of view of the internal camera 515. Similarly, the external camera 510 is positioned on a pivotal member 525, which is pivotally coupled to the body 520, to adjust a field of view of the external camera 510. As such, each of the internal and external cameras 510, 515 may be configured to obtain good fields of view both inside and outside of the vehicle.

The system 500 includes a power cord 530, which is configured to be coupled to a cigarette lighter outlet of the vehicle, to charge a battery of the system 500. As such, when power is no longer provided through the power cord 530 (e.g. when the vehicle is parked), the system 500 may draw power from the battery to operate.

Finally, the system 500 includes buttons 535, to configure the system, and control lights 540, to view a configuration of the system 500. For example, the lights 540 may illuminate in a particular colour to indicate that motion has been detected, and the buttons 535 may be used to adjust a sensitivity of the system 500.

According to certain embodiments, the systems described above may also be used for other purposes. For example, an alarm may be sounded if travelling too close to a vehicle, or if parking sensors are activated.

The system 100, 200, 500 may be used to remotely start the vehicle and engage heating or cooling for comfort purposes, i.e. without detecting a presence of a child. Similarly, any other function of the vehicle may be activated, such as a radio.

Real time streaming of both internal and external images may be provided to a remove device, with our without detecting a presence of a child.

The system 100, 200, 500 may include a panic button to be used in event of carjacking or any other life threating situation that requires immediate attention of authorities. The system 100, 200 may also activate an engine immobilizer to stop the vehicle in a theft or carjacking.

The camera 210 may be used to detect a driver by facial recognition, and to adjust central vehicle electronics to individual preferences as well as serve as extra protection in thefts or illegal activities.

The camera may also be used to scan a driver's licence, to ensure persons who intend to operate vehicle are fully licensed and able. Similarly, the system 100, 200 may include a Breathalyzer, to ensure sobriety of persons who intend to operate vehicle.

Cameras may be provided that are directed to an outside of the vehicle, which may be used to monitor traffic, driver behaviour, provide parking or reversing assistance, or the like.

In particular, the system may function as a dash camera when the vehicle is in operation. In case the system detects a crash while driving, it may save video recorded immediately prior thereto for later use. The system may also send details of the accident (including for example images, location information and the like) to one or more registered users by SMS, MMS, email or the like.

The system may include a g-force sensor, for crash detection, or any other suitable sensor. Furthermore, the crash detection threshold may be user configurable.

Similarly, the system may also provide crash prevention functionality. For example, the system may detect fatigue, and provide alerts in relation thereto. Similarly, the system may provide an alert periodically (e.g. once per hour) to alert the driver that the interval has passed, enabling the driver to make better decisions regarding taking breaks.

According to certain embodiments, a user may request images of the vehicle on demand. For example, the user may request an image from an interior of the vehicle, upon which said image is sent to the user.

According to certain embodiments, the systems described above may be split into front and rear modules. For example, a front module may be for detecting movement in a front of the vehicle, and the rear module may be for detecting movement in a rear of the vehicle. However, the skilled addressee will readily appreciate than any suitable number of modules may be interconnected to provide coverage for alternative areas of the vehicle, or to providing complementing data from the vehicle.

The front and rear modules may be wirelessly connected. In such case, one of the front and rear modules may function as a master, and the other may function as a slave. In such case, the master may be responsible for collating data and communicating the data externally.

According to certain embodiments, the system may automatically detect when the vehicle is parked. This may be from a positioning sensor, motion sensors, or any other suitable sensor. As such, the system may automatically switch between monitoring configurations (when parked) and dash cam configurations when driving.

The systems and methods described above addresses the issue of dehydration by immediately cooling the car, without having to wait for a rescue worker or the owner to arrive.

The present invention detects a presence of a child in a vehicle, for example based upon movement, which is more accurate than child restraint based devices. In particular, such embodiments of the invention address child death scenarios even when a child is not strapped into a seat.

The system 100, 200 may prevent hypothermia in cold environments, by activating a heater in freezing temperatures.

The system 100, 200 can protect again theft and vandalism by recording images and including GPS tracking, which both acting as a strong deterrent for would be thieves.

The system 100, 200 may also have the ability to better understand who is at fault in a traffic collision, by cross referencing internal and external environmental activity.

The system 100, 200 may also be used to monitor illegal activity, from drink driving to internal environment and contributing factors within the vehicle in the event of a traffic accident. It can prove negligence of parents who intentionally leave children in vehicles or even parents that smoke in vehicles with children present. As such, the present invention may also be used for parents who are repeat offenders or “under watch” by child protection agencies.

Finally, based upon the above, the systems 100, 200 may be used to provide a reduction in insurance claims, thus resulting in a reduction in premiums. Furthermore, a reduction in crime rate may be resultant, reducing strain on our court and justice system. Most importantly, the lives of many innocent children may be saved through use of the system 100, 200.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-29. (canceled)

30. A vehicle safety system configured to be installed in a vehicle, the vehicle safety system comprising:
a sensor, to sense the presence of a child or animal in a stationary vehicle;
a controller, configured to issue an alert in response to the detection of the presence of the child or animal in the vehicle when the vehicle is not in operation; and
a mount, coupled to the sensor and the controller, configured to mount the vehicle safety system in the vehicle by releasably engaging with an interior surface of the vehicle, such that the sensor is directed towards an interior of the vehicle.

31. The vehicle safety system of claim 30, further comprising:
a camera, coupled to the mount, and a memory, the camera configured to capture images from the vehicle when the vehicle is in operation and save the images in the memory, wherein in the mount is configured to mount the vehicle safety system such that the camera is directed towards an exterior of the vehicle while the sensor is directed towards an interior of the vehicle.

32. The vehicle safety system of claim 31, wherein the camera is pivotally attached to the mount.

33. The vehicle safety system of claim 30, wherein the controller is configured to control a change in temperature in the vehicle in response to the detection of the presence of the child or animal in the vehicle.

34. The vehicle safety system claim 31, wherein the controller is configured to cause a temperate of the vehicle to decrease by activating a fan of the vehicle, activating air conditioning of the vehicle and/or opening a window of the vehicle.

35. The vehicle safety system of claim 30, further comprising a temperature sensor, for sensing a temperature in the vehicle.

36. The vehicle safety system of claim 35, wherein the controller is configured to selectively increase or decrease the temperature in the vehicle based upon the temperature of the vehicle.

37. The vehicle safety system of claim 30, wherein the controller is configured activate an alarm or signaling device of the vehicle.

38. The vehicle safety system of claim 30, further comprising a rechargeable battery, for powering the system, which rechargeable battery is independent to a battery of the vehicle.

39. The vehicle safety system of claim 30, further comprising the controller is configured to send a message to a remote device, based at least in part on the presence of the child or animal in the vehicle.

40. The vehicle safety system of claim 30, further comprising a positioning module, for determining a position of the vehicle, wherein the position of the vehicle is sent in a message to a remote device.

41. The vehicle safety system of claim 30, wherein the controller is configured to send a first message when first threshold criteria are met, and a second message when second threshold criteria are met.

42. The vehicle safety system of claim 30, further comprising a camera, to capture images of an interior of vehicle.

43. The vehicle safety system of claim 30, wherein the system is configured to be placed on a front dash of the vehicle such that the sensor is directed backwards toward an interior of the vehicle.

44. A vehicle safety method comprising:
mounting, using a mount, a vehicle safety system in a vehicle, by releasably engaging with an interior surface of the vehicle, such that a sensor of the vehicle safety system is directed towards an interior of the vehicle;
determining whether the vehicle is in operation;
sensing, using the sensor in the vehicle, the presence of a child or animal in the vehicle; and
issuing an alert in response to the detection of the presence of the child or animal in the vehicle when the vehicle is not in operation.

45. The vehicle safety method of claim 44, further comprising:
capturing images from the vehicle when the vehicle is in operation and save the images in the memory, wherein in the mount is configured such that the camera is directed towards an exterior of the vehicle while the sensor is directed towards an interior of the vehicle.

46. The method of claim 44, further comprising sensing a temperature in the vehicle.

47. The method of claim 44, further comprising activating an alarm associated with the vehicle.

48. The method of claim 44, further comprising sending a message to a remote device, based at least in part on the presence of the child or animal in the vehicle.

49. The method of claim 48, further comprising determining a position of the vehicle, and providing the position in the message to the remote device.
